(19) United States
(12) Patent Application Publication
(10) Pub. No.: US 2026/0200715 A1
(43) Pub. Date: Jul. 16, 2026

(54) DEVICE FOR LIFTING HEAVY ARTICLES

(71) Applicant: BRUCE E. WARN, Mason City, IA (US)

(72) Inventor: BRUCE E. WARN, Mason City, IA (US)

(21) Appl. No.: 19/432,093

(22) Filed: Dec. 23, 2025

Related U.S. Application Data
(60) Provisional application No. 63/745,776, filed on Jan. 15, 2025.

(51) Int. Cl. B66F 19/00

(52) U.S. Cl. CPC B66F 19/00

(57) ABSTRACT

A device for lifting and transporting heavy, large, and planar articles is disclosed. The device includes an elongated flexible strap having a proximal end and a distal end, an engagement member disposed at the proximal end and configured to engage a lower edge of an article, and a handle grip disposed at the distal end for manual lifting. The engagement member retains the lower edge of the article to enable lifting while allowing a user to maintain an upright posture. The device reduces physical strain during lifting and carrying and enables a single user to safely move planar articles such as plywood, sheetrock, and lumber in personal and commercial environments.

### CROSS REFERENCE TO RELATED APPLICATIONS

This application claims priority from a U.S. Provisional Patent Appl. No. 63/745,776, filed on 01/15/2025, which is incorporated herein by reference in its entirety.

### FIELD OF INVENTION

The present invention relates generally to material-handling devices, and more particularly, to a device for lifting, carrying, and transporting heavy articles. The invention is especially applicable to large, planar construction materials such as plywood, sheetrock, drywall, panels, and lumber.

### BACKGROUND

Lifting and transporting large, heavy, and planar articles such as plywood, sheetrock, and lumber is a common task in construction sites, warehouses, manufacturing facilities, and do-it-yourself projects. Due to their size, weight, and shape, such articles are often difficult to grip, balance, and maneuver manually.

Conventional handling of these articles typically requires two or more individuals to lift and carry the material safely. Even when multiple individuals are involved, the lifting process often places the body in awkward or strained postures, resulting in discomfort, fatigue, or injury to the hands, arms, shoulders, or back.

In many situations, assistance from additional persons may not be readily available, requiring a single individual to lift or move the article alone. Attempting to do so increases the risk of musculoskeletal injury and makes the task inefficient, time-consuming, and potentially unsafe

Accordingly, there exists a need for an improved device that enables a single user to lift, carry, and transport large, heavy, and planar articles more easily, efficiently, and safely, while reducing physical strain and the likelihood of injury.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The principal object of the present invention is to provide a device for lifting and transporting heavy, large, and planar articles, such as lumber and sheetrock, while reducing strain on a user’s hands and back.

Another object of the present invention is to provide a device that is compact and flexible, allowing the device to be easily stored in a standard-size toolbox, tool bag, or pocket.

Another object of the present invention is to provide a versatile device that may be manufactured in different configurations and is adjustable or adaptable based on manufacturing processes.

Another object of the present invention is to provide a device that facilitates safer and easier lifting and carrying of large, heavy, and planar articles.

Another object of the present invention is to provide a device that is lightweight and portable.

Another object of the present invention is to provide a device that can be adapted to lift and transport articles of different sizes.

Another object of the present invention is to provide a device suitable for use in both personal and commercial applications.

The present invention provides a device and method for lifting and transporting heavy, large, and planar articles in a safe, efficient, and ergonomic manner. The device is particularly useful for handling construction materials such as plywood, sheetrock, drywall, panels, and lumber, which are typically difficult to lift and carry using conventional techniques.

In one aspect, the invention includes a lifting device having an elongated flexible strap with a proximal end and a distal end. An engagement member is disposed at the proximal end of the strap and is configured to engage and retain a lower edge of a planar article. A handle grip is disposed at the distal end of the strap and is configured to be grasped by a user to lift and carry the article.

When the engagement member is engaged with the lower edge of the planar article and an upward force is applied through the handle grip, the article is supported in a manner that allows the user to maintain a substantially upright posture during lifting and

transportation. This configuration reduces strain on the user’s hands, arms, shoulders, and back as compared to lifting the article directly.

In certain embodiments, the engagement member includes a tubular structure having a base and opposing walls defining an opening sized to receive the lower edge of the planar article. The strap may be formed from a flexible and durable material and may be reinforced to withstand repeated lifting loads. The handle grip may include an opening or ergonomic features to improve comfort and control during use.

The device may be compact, lightweight, and portable, allowing it to be easily stored in a toolbox, tool bag, or pocket when not in use. The device may be manufactured in different sizes and configurations to accommodate planar articles of varying dimensions and weights.

In another aspect, the invention provides a method for lifting and transporting planar articles using the disclosed device. The method includes engaging the engagement member with a lower edge of the planar article, grasping the handle grip, and applying an upward force to lift and transport the article while maintaining an upright posture. The method enables a single user to safely move large planar articles without external assistance.

These and other features, advantages, and applications of the present invention will be apparent from the following detailed description and the accompanying drawings.

### BRIEF DESCRIPTION OF DRAWINGS

The accompanying figures, which are incorporated herein, form part of the specification and illustrate embodiments of the present invention. Together with the

description, the figures further explain the principles of the present invention and to enable a person skilled in the relevant arts to make and use the invention.

FIG. 1 shows a perspective view of a device, according to an exemplary embodiment of the present invention.

FIG. 2 shows another perspective of the device, according to an exemplary embodiment of the present invention.

FIG. 3 shows an enlarged view of a proximal end portion of the device, according to an exemplary embodiment of the present invention.

FIG. 4 shows an enlarged view of a distal end portion of the device, according to an exemplary embodiment of the present invention.

FIG. 5 shows the device in a use-state condition, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter,

including methods, devices, components, and systems. Accordingly, the following detailed description is not intended to be taken in a limiting sense.

As used herein, the term "exemplary" is intended to mean “serving as an example, instance, or illustration.” Any embodiment described as "exemplary" should not be construed as preferred or more advantageous over other embodiments. Similarly, the expression "embodiments of the present invention" does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

Disclosed is a device for lifting and carrying heavy, large, and planar articles, such as plywood, sheetrock, drywall, and lumber. The disclosed device enables one or more users to easily and efficiently lift such articles. A user is not required to bend the body and may maintain a substantially upright and ergonomically healthy posture while lifting and carrying

the articles. The device significantly reduces physical strain on the hands, arms, and back as compared to directly lifting the articles. In certain use cases, a single user can safely lift and transport a large sheet of plywood or sheetrock without external assistance.

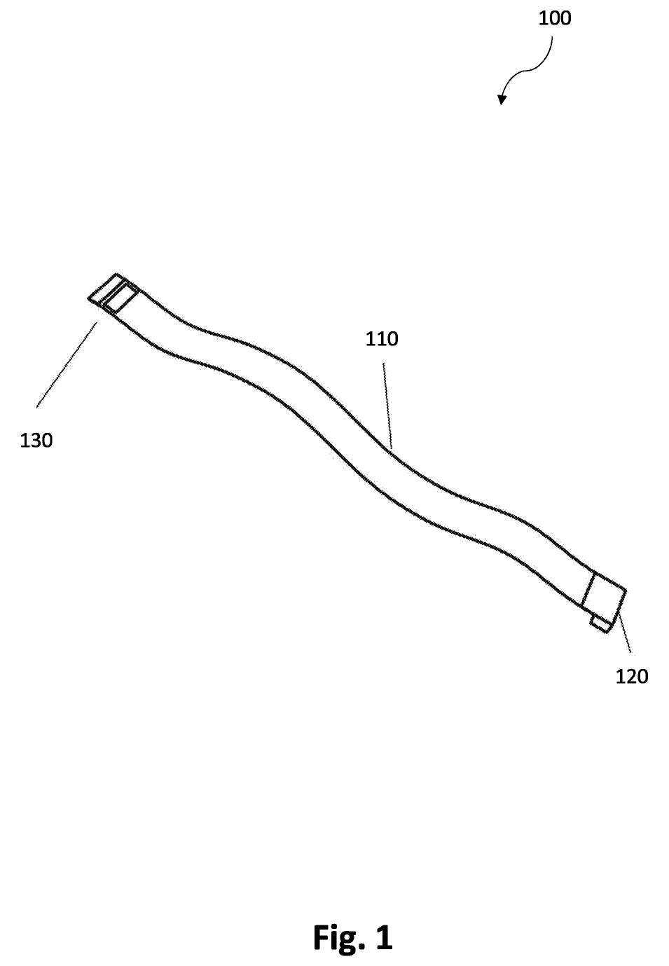

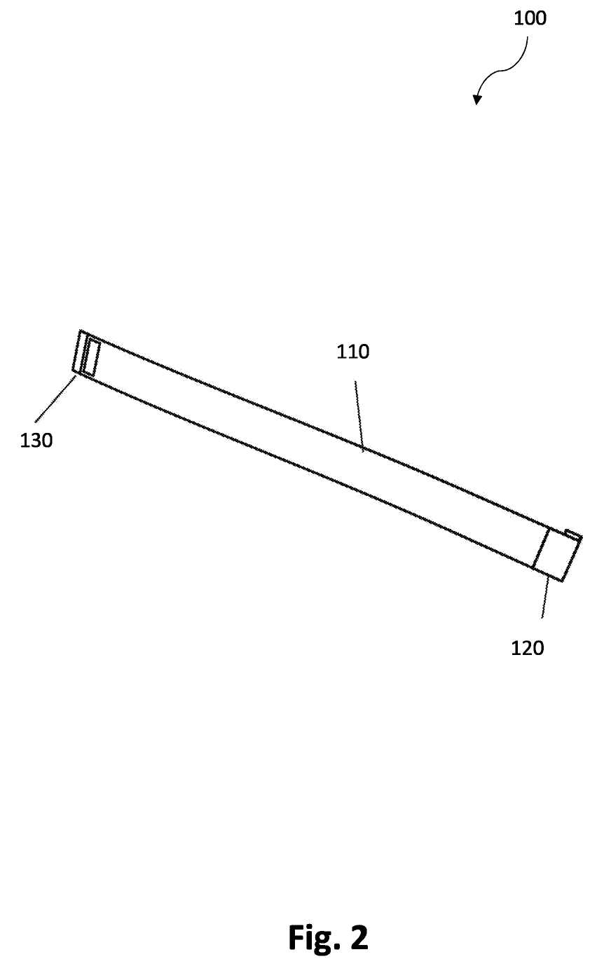

Referring to FIGS. 1 and 2, which illustrate different perspective views of the device 100, the device 100 includes an elongated and flexible strap 110. By way of example and not limitation, the strap 110 may be approximately 5 inches wide and 35 inches long. It is understood that the strap 110 may be manufactured in different lengths and widths depending on the intended use and manufacturing requirements. The strap 110 may be formed from any suitable material, such as nylon or other synthetic or natural materials, and all such materials are within the scope of the present invention. In certain embodiments, the strap 110 may be reinforced or strengthened using suitable methods, such as bonding, coating, or application of epoxy.

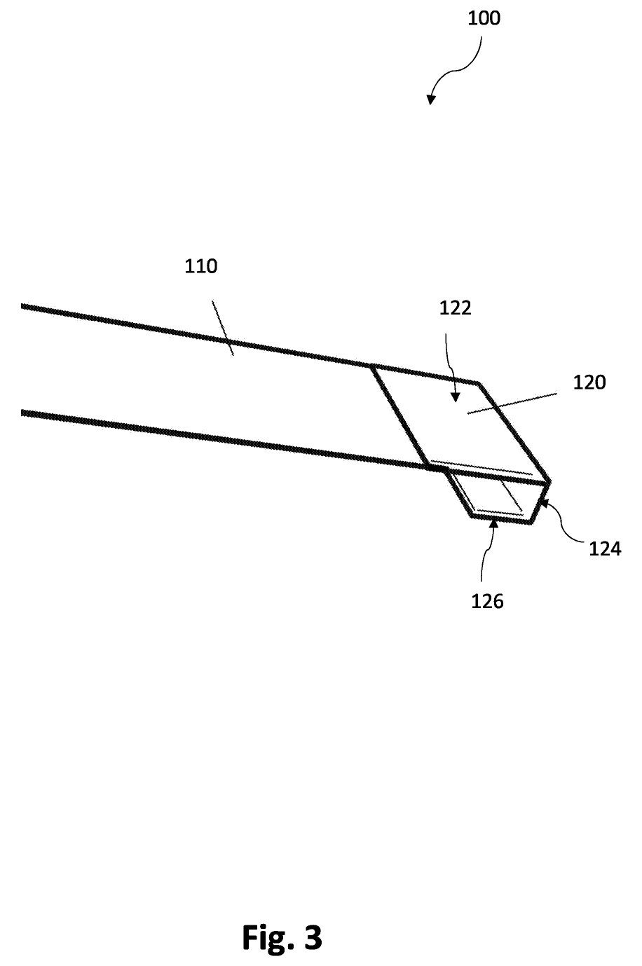

The device 100 further includes a square tubing 120 disposed at a proximal end of the strap 110, as more clearly shown in FIG. 3. The square tubing 120 functions as a gripping or engagement member configured to engage a lower edge of an article to be lifted. The square tubing 120 includes a base 124 and two parallel, opposing walls 122 and 126 extending perpendicularly from opposing edges of the base 124. An opening defined between the opposing walls is sized to receive a bottom edge of the article. The strap 110 is coupled to one of the walls of the square tubing 120. When installed, the lower edge of the article is retained between the opposing walls of the square tubing 120 to facilitate lifting.

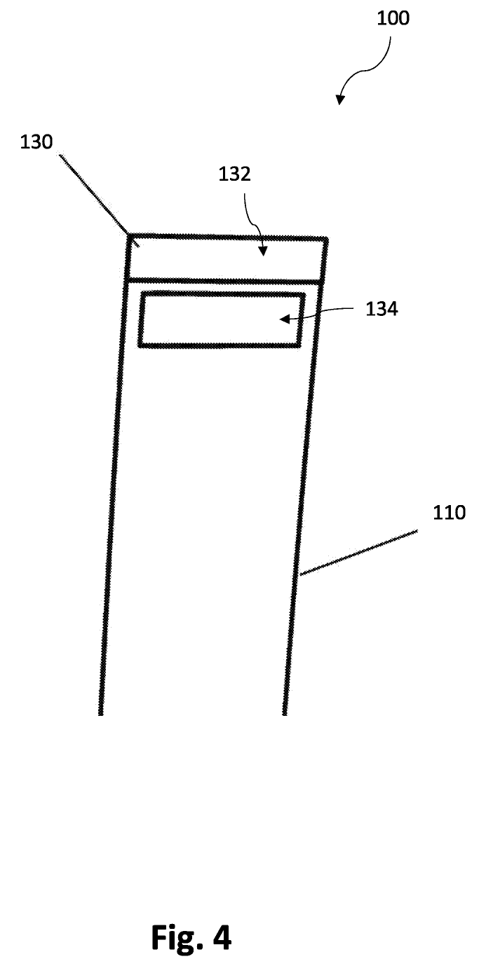

Referring to FIG. 4, the device 100 further includes a handle grip 130 disposed at a distal end of the strap 110. The handle grip 130 is configured to be grasped by a hand of a

user. In certain embodiments, the handle grip 130 may be ergonomically shaped to provide comfortable handling and to reduce strain on the user’s hand. As illustrated, the distal end 132 of the strap may be reinforced through bonding or other strengthening techniques. An elongate opening 134 may be formed near the distal end 132, allowing the user to insert a hand through the opening and grasp the strap during use.

In certain implementations, a foot-activated cradle or lifting aid may be used to slightly elevate the article to facilitate placement of the square tubing 120 onto the lower edge of the article. The cradle may be actuated by a user’s foot to temporarily lift the article while the device 100 is positioned.

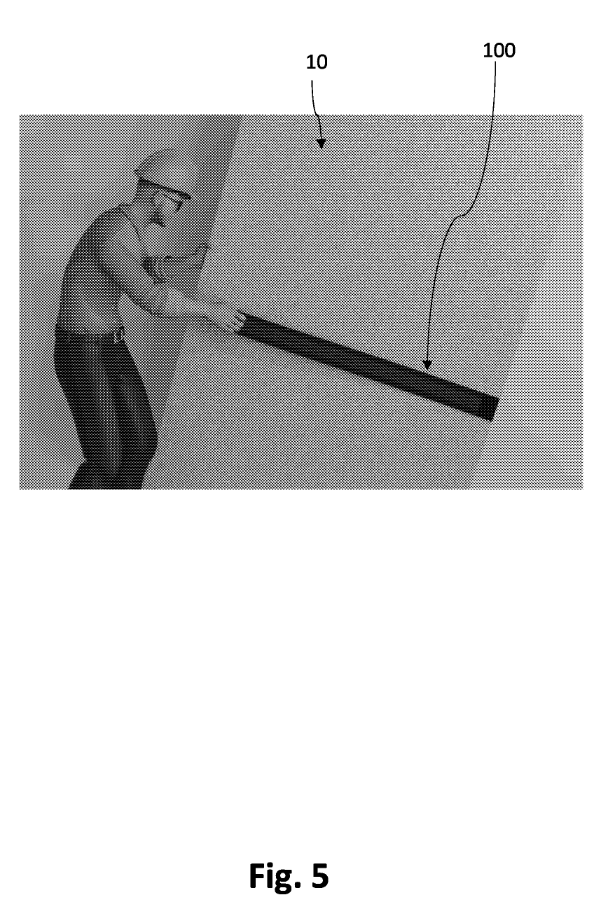

Referring to FIG. 5, which illustrates a use condition of the device 100, a user 10 is shown lifting an article 20 using the disclosed device 100. The article 20 is a large planar article, such as a sheet of plywood. The square tubing 120 is engaged with a lower edge 22 of the article 20. The user pulls upward on the device 100 with one hand while stabilizing the article with the other hand. In this manner, a single user can lift and carry the large planar article 20 while maintaining an upright posture and without excessive bending of the body.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A device for lifting and transporting a planar article, comprising:
an elongated flexible strap having a proximal end and a distal end;
an engagement member disposed at the proximal end of the strap, the engagement member being configured to receive and retain a lower edge of the planar article; and
a handle grip disposed at the distal end of the strap and configured to be grasped by a user,
wherein the engagement member supports the planar article during lifting such that the user is able to lift and carry the planar article while maintaining a substantially upright posture.

2. The device of claim 1, wherein the planar article comprises at least one of plywood, sheetrock, drywall, paneling, or lumber.

3. The device of claim 1, wherein the engagement member comprises a square tubing having a base and two opposing walls extending from the base, the opposing walls defining an opening configured to receive the lower edge of the planar article.

4. The device of claim 1, wherein the handle grip includes an opening configured to receive a hand of the user.

5. The device of claim 1, wherein the engagement member is coupled to the strap along one wall of the engagement member.

6. A method for lifting and transporting a planar article, comprising:
providing a lifting device comprising an elongated flexible strap having a proximal end and a distal end, an engagement member disposed at the proximal end, and a handle grip disposed at the distal end;
positioning the engagement member at a lower edge of the planar article such that the lower edge is received by the engagement member;
grasping the handle grip with a hand of a user; and
applying a pull force through the handle grip to lift and transport the planar article while the user maintains a substantially upright posture.

7. The method of claim 6, wherein the planar article comprises at least one of plywood, sheetrock, drywall, paneling, or lumber.

8. The method of claim 6, wherein positioning the engagement member comprises engaging the lower edge of the planar article between two opposing walls of the engagement member.

9. The method of claim 6, further comprises stabilizing the planar article with a second hand of the user while lifting the planar article.
